(19) United States
(12) Patent Application Publication
(10) Pub. No.: US 2005/0244768 A1
(43) Pub. Date: Nov. 3, 2005

(54) Device and method for applying an abutment force between dental appliance and teeth

(76) Inventors: Eldad Taub, Reut (IL); Avi Kopelman, Ramat Chen (IL)

Correspondence Address: NATH & ASSOCIATES, PLLC;Sixth Floor, 1030 15th Street, N.W., Washington, DC, 20005, US

(21) Appl. No.: 11/114,038

(22) Filed: Apr. 26, 2005

Related U.S. Application Data
(60) Provisional application No. 60/565,856, filed on Apr. 28, 2004.

(51) Int. Cl. A61C 3/00

(52) U.S. Cl. 433/3; 433/6

(57) ABSTRACT

A method and device for facilitating the secure bonding of such appliances to the teeth by the application of a suitable abutment force external to and independent of an indirect bonding tray or the like used in connection with such bonding.

### FIELD OF THE INVENTION

This invention relates to a method and apparatus for bonding orthodontic appliances to teeth, specially, via indirect bonding. In particular, the present invention is concerned with facilitating the secure bonding of such appliances to the teeth by the application of a suitable abutment force external to and independent of an indirect bonding tray or the like used in connection with such bonding.

### BACKGROUND OF THE INVENTION

Orthodontics is the branch of dentistry dealing with teeth irregularities and their corrections, such as by means of braces. The primary purpose of orthodontic treatment is to alter the position and reorient an individual's teeth so as to modify or improve their function. Teeth may also be reoriented mainly for cosmetic reasons.

In orthodontic treatment, as currently practiced, it is necessary to affix various orthodontic components to the surfaces of a patient's teeth. (In this specification, we shall only refer to brackets as the orthodontic element or component to be anchored on a tooth's surface, but it is to be understood that this is only by way of example, and the invention applies to all other types of orthodontics elements, mutatis mutandis, such as for example tubes, springs and other appliances.) The location of the bracket on the tooth as well as its orientation is a critical factor in determining the direction of movement of the teeth during the treatment, and accurate placement may ensure that the teeth are aligned with a single bracket bonding treatment. Conversely, less accurate placement of brackets may require repeated treatments, including repeated bonding and wire bending procedures until the final alignment is achieved. Once the position of the brackets has been decided upon, it is thus critical that a good bond is established between the brackets and the teeth at that position: brackets affixed to teeth surfaces serve to support wires and tensioning springs to exert moments of force acting to move the teeth subjected to these forces to a degree and in a direction causing the teeth to assume a desired posture in the dental arch.

In current orthodontic practice, the orthodontist decides on a general scheme of placing the brackets on the teeth and then attaches each of them to the surface of a tooth, in an exact location and orientation previously decided. Preparatory to an orthodontic treatment, the orthodontist typically prepares a plaster model of the teeth of the treated individual and on the basis of such model, the general scheme of placement of the brackets can be decided.

A typical treatment plan includes, among other factors, the desired position of each of the force-inducing orthodontic implements on the teeth. The placement of the brackets on the teeth determines the outcome of the above-mentioned movements, e.g. the degree and direction of the teeth movements. Any deviation from the planned position of the brackets affects the outcome of the treatment. Thus, during the process of placing the brackets on the teeth, much effort is made to ensure the accurate positioning of the brackets in accordance with their desired position as determined by the treatment plan, and to ensure that the brackets are properly bonded to the teeth at these positions.

The brackets are typically placed on the buccal surface of the teeth, though at times, it is desired both from a treatment perspective as well as for reasons of external appearance of the individual, to place the brackets on the lingual surface of the teeth.

Typically, the following general steps are conducted for properly positioning an orthodontic element such as a bracket on a tooth surface, and then fixing the bracket thereto, according to the so-called direct bonding method:
Step I: The orthodontist brings the element, being held by the positioning tool, into proximity of the tooth;
Step II: The orthodontist then positions the orthodontic element on the tooth surface at the site coinciding with its intended position, and disengages it from the positioning tool. Different gauges or other tools may be used to assist the orthodontic in placing the brackets on site, for example as described in http://www.oc-j/products/bracspos.htm.
Step III: Finally, the element is affixed to the designated site by a bonding agent.

Typically, the bonding of the bracket to the tooth is achieved by using either chemical adhesives or light curing adhesives. Chemical adhesives are typically cured by themselves, and the curing begins as the adhesive coming in contact with the tooth surface is completely cured after some self-working time (typically about 1 to 3 minutes).

The difficulty with manual orthodontic procedures, as commonly practiced nowadays, is that they are subject to human error. In the first place, it is very hard to place the bracket where it is desired to be located. Another common difficulty relates to the disengagement of the bracket from the positioning tool, as this process typically causes a slight movement of the bracket on the tooth due to inherent and uncontrolled small human movements. This difficulty is compounded when the orthodontist must place brackets not only on buccal tooth surfaces but also on lingual surfaces. With existing methods, it is not easy for an orthodontist to properly position brackets on lingual surfaces. Nevertheless, once positioned, each bracket may be held in place until the bonding process is complete, with relative little difficulty.

Another form of positioning brackets is known as indirect bonding, and is traditional based on forming a tray of a thermoplastic material, or any other suitable material, over a physical model of the teeth on which the brackets have been positioned using a relatively weak adhesive, for example as described in U.S. Pat. No. 3,738,005. The brackets may be positioned onto the model in any one of a number of ways, for example as disclosed in U.S. Pat. No. 4,812,118. The tray thus comprises a negative impression of the teeth model, which is very close-fitting with respect thereto, and also has the brackets embedded in position in the tray in their correct positions with respect to the model. The tray can then be removed from the model, taking with it the brackets in the correct relative positions with respect to the negative impression. The tray is then transferred to the intraoral cavity of the patient, and when properly fitted over the appropriate arch, presents the brackets in ostensibly the correct positions vis-à-vis the teeth. It is then attempted to bond the brackets simultaneously onto the teeth, and the tray may then be removed, leaving the brackets in place.

This method is commonly practiced, and can be used for both buccal and lingual brackets. Most of the preparatory work is done by a technician rather than the dentist, and the technique results in a shorter installation time than when the brackets are installed manually one at a time, but the technician needs to have a supply of brackets readily available. This method also requires all the teeth to be dry and pre-etched, before bonding begins.

Sometimes there are small dimensional mismatches between the tray and the teeth, and may result in at least some of the brackets not being in full abutting contact with the teeth. Since the brackets are fully constrained in all six degrees of freedom by the tray, the brackets can only be made to abut the teeth by making use of the elasticity of the tray and manually pressing the brackets towards the teeth. The orthodontist is not always fully aware if and which brackets are not properly abutted, and in practice, many failures occur due to the imperfect fit between the tray and the teeth, resulting in part due to the dimensional differences between the plaster model and the actual teeth, and also due to distortion of the tray after it is removed from the plaster model.

Even when it is known that some of the brackets are not properly abutting the teeth, it is often impractical to manually press all such brackets against their corresponding teeth simultaneously and to hold them in place while the bonding process is completed. When using chemical adhesive, with bonding times typically between 1-3 minutes, invariably some brackets are better bonded than others. Often one or more brackets are not fixed properly onto the teeth, and these need to be reset manually later, and without the aid of the tray. When using light-curing adhesive, each bracket in turn may be manually clamped onto the tooth by the orthodontist while it is being cured to ensure that it is properly fixed. However, this is a very cumbersome procedure, and the orthodontist is not always able to manually clamp the tooth. In any case, the elapsed time taken to conduct this procedure for a number of teeth in succession may result in at least some of the remaining teeth becoming less dry, which also hampers the quality of the-bond.

In U.S. Pat. No. 4,501,554, a two tray system is used for transferring brackets to teeth, a second, rigid tray being inserted over a first traditional tray that carries the brackets. The second tray is provided for substantially preventing movement between the brackets and the teeth that may occur due to slight distortions that may occur in the first tray during placement of the same over the teeth. However, the first tray is fabricated based on a plaster model of the teeth, and dimensional inaccuracies between the two are not addressed by the patent.

In U.S. Pat. No. 6,123,544, brackets are held on arms that are connected to a transfer tray, rather than being attached to the tray itself. The arms are aligned with respect to a plaster model of the teeth, and each arm is connected to a bracket which was previously positioned on the plaster model. The tray is formed over the arms, the arms together with their corresponding brackets are slid away from the model teeth, and the assembly is removed from the plaster model. The assembly is placed into the intraoral cavity, and the arms are then retracted into the tray enabling the brackets to contact the teeth at the predetermined positions, where they can be bonded onto the teeth at the contact points. As with the traditional indirect bonding technique, dimensional inaccuracies between the model and the real teeth can lead to inaccurate placement.

Of general background interest, the following references disclose tray-based orthodontic methods and devices.

In U.S. Pat. No. 5,971,754 adhesive is provided in two components, one applied to the teeth and the other to the bracket while embedded in the tray. When the two components come together, a bond forms within a short time period to enable removal of the tray without significantly changing the position of the appliance.

In U.S. Pat. No. 4,360,341, a variation of the traditional transfer tray is provided, in which the brackets are held in the tray by bracket orienting modules, providing positioning accuracy of the brackets.

### SUMMARY OF THE INVENTION

The term “dental appliance” herein refers to one or a plurality of orthodontic elements. The term “element” is used herein to denote a device which is fixed on to a tooth within the framework of an orthodontic treatment, e.g. a bracket, tubes, springs and other elements.

The present invention relates to a device for applying an abutment force between a dental appliance carried on a holder and at least one tooth. In other words, the device may be used for urging one or more orthodontic elements of a dental appliance towards one tooth, towards either the buccal or lingual, or both sides thereof (in some cases where more than one element is used). The device may also be used for urging against each one of a plurality of teeth, one or more orthodontic elements, with respect to the either the buccal or lingual, or both sides thereof (in some cases where more than one element is used). In each case, the holder is seated on one or more teeth such that the one or more elements are each in registry with the desired said one or more teeth. The device comprises:—
abutment means, typically carried in a housing; and
mounting means for mounting the device with respect to one or more teeth and said holder,
wherein said abutment means are adapted for generating a suitable force for urging, directly or indirectly, each element of the said appliance into abutting contact with said one or more teeth.

Typically, the appliance is urged indirectly towards the tooth by applying he force onto the holder. In some cases, though, a part of the appliance may rotrude to outside of the holder, and the abutment means may apply the force directly to the one or more orthodontic elements.

In some embodiments, the mounting means may comprise hook elements for hooking the device with respect to one or more said teeth, or cups that engage with the end teeth of an arch comprising said one or more teeth, or an inverted trough adapted for receiving and engaging at least a part of an arch in an intraoral cavity in occlusal arrangement with respect to an arch that comprises said one or more teeth.

In another embodiment, the mounting means comprises a trough generally shaped to receive said one or more teeth having seated thereon said holder. In this embodiment, the housing comprises an opening in communication with the trough.

The abutment means may be powered and thus based on any suitable powered actuation means, including for example, any one of suitable pneumatic, hydraulic, electrical or mechanical actuation. Alternatively, the abutment means may be manually actuated by the orthodontist or an assistant, for example.

For example, the abutment means may comprise an inflatable element, said inflatable element being reversibly inflatable from a deflated configuration to an inflated configuration. In the inflated configuration at least a part of said inflatable element is pressed against the said holder at least in a vicinity of said one or more appliances such that said appliance is abutted against said one or more teeth. Typically, the inflatable element is in the form of a balloon member accommodated in said housing. The balloon member may be arcuate in form, and comprise a substantially uniform cross-section along the length thereof. Alternatively, the balloon member comprises a plurality of globular portions arranged in series along the length thereof. Typically, the inflatable element is operatively connected to a suitable pressurized fluid supply, such as for example air or water. Alternatively, the balloon member may be connected to a manual pump, to be actuated manually by the user when required.

Alternatively, the abutment means may comprise one or more electrical actuators accommodated in said housing and each having a piston arrangement reversibly actuable from a retracted position to an extended position. In the extended position, a pressure pad comprised at one end of a said piston is pressed against the said holder at least in a vicinity of at least one said appliance such that said appliance is abutted against said one or more teeth.

Alternatively, the abutment means comprise one or more mechanical actuators accommodated in said housing and each having a cam arrangement reversibly actuable from a raised position to a return position. In the raised position, a pressure pad comprised in said housing is pressed by a said cam arrangement against the said holder at least in a vicinity of said appliance such that said appliance is abutted against said one or more teeth.

In one embodiment, the device is adapted for applying an abutment force between a dental appliance carried on a holder and one or more teeth of an arch, wherein said holder is adapted for being seated over the full arch, said trough having a plan profile substantially similar to that of said arch for receiving and holding therein said arch with said holder seated thereon. Advantageously, the housing also comprises a plan profile substantially similar to that of said arch. In one such embodiment, the housing is arranged buccally with respect to said trough. In another embodiment, the housing is arranged lingually with respect to said trough. In another embodiment, the device comprises a second housing suitable abutment means, one housing being arranged lingually and the other housing being arranged buccally with respect to the trough.

Advantageously, the device is adapted for applying the abutment force to a plurality of orthodontic elements comprised in said appliance substantially simultaneously.

Optionally, the device comprises light transmission means for transmitting light to an abutment area between said appliance and said one or more teeth during operation of said device. The light is of a wavelength suitable for curing light-curable adhesive that may be used for bonding said appliance to said one or more teeth. In such cases, some and preferably all the components and elements of the device that are situated in the optical path between the light source and the appliance are made from a transparent material, or at least translucent material.

The light source may be intra-orally located during operation of the device, and thus comprise, for example, one or more suitable LED's mounted on the device. Alternatively, the light source may be an extra oral source, in optical communication with the device via light guides such as for example optic fibers. The light may be transmitted from the side on which the appliance is mounted—for example, from the buccal direction when dealing with a buccal bracket. Alternatively, the light may be transmitted from the opposite direction to that of the appliance—for example, on the lingual direction on a buccal tube, in which case use is made of the tooth's translucency. Alternatively, the light may be provided via the occlusal direction, or indeed the gingival direction or the mesiodistal direction where possible. Optionally, the light may be provided in any combination of at least two of the aforesaid directions, or indeed any other direction.

The present invention is also directed to a method for abutting a dental appliance to at least one tooth, said appliance being carried on a holder, comprising the steps of:
seating said holder on said at least one tooth such that said appliance is in registry with said at least one tooth;
mounting an abutment device with respect to said holder and said at least one tooth, said device comprising:—abutment means; and mounting means for mounting the device with respect to said at least one tooth and said holder,
generating a suitable abutment force via said abutment means for urging said appliance into abutting contact with said at least one tooth.

Optionally, the method further comprises the step of bonding said appliance to said at least one tooth.

The present invention is also directed to a method for bonding a dental appliances to one or more teeth, said appliance being carried on a holder, comprising the steps of:
seating said holder on said one or more teeth such that said one or more appliance is in registry with the desired said one or more teeth;
mounting an abutment device over said holder and teeth, said device comprising:—abutment means; and mounting means for mounting the device with respect to said one or more teeth and said holder,
generating a suitable abutment force for urging the said appliance into abutting contact with said one or more teeth;
bonding said dental appliance to said one or more teeth.

Typically, the holder is in the form of a tray and is adapted for being seated over the full said arch, wherein said mounting means is in the form of a trough having a plan profile substantially similar to that of said arch for receiving and holding therein said arch with said holder seated thereon.

According to the positioning required for the appliances, if at least one of the orthodontic elements comprised in said appliance is to be bonded lingually to a said tooth, the abutment force may be applied buccally. Alternatively, if at least one of the orthodontic elements comprised in said appliance is to be bonded lingually to a said tooth, the abutment force may be applied lingually with respect to said teeth. Alternatively, if at least one orthodontic element is to bonded lingually, and at least one orthodontic element is to be bonded buccally, the method further comprises the step of applying a second abutment force, wherein the first mentioned abutment force is applied lingually for pressing the buccal elements, and the second abutment force is applied buccally for pressing the lingual elements, with respect to the teeth.

Preferably, the abutment force(s) is/are applied to a plurality of said orthodontic elements comprised in said appliance substantially simultaneously.

Optionally, a light-curing adhesive is applied to said appliance prior to seating said holder on said one or more teeth. The method may further comprise the step of applying a light transmission to an abutment area between said one or more dental appliances and said one or more teeth during operation of said device, wherein said light is of a wavelength suitable for curing light-curable adhesive that may be used for bonding said one or more appliance to said one or more teeth. The light may be provided in any one of a buccal, lingual, mesiodistal, occlusal, mesiodistal or gingival direction or combination of at least two thereof.

Alternatively, a chemically-curing adhesive may be applied to said appliance prior to seating said holder on said one or more teeth

The term “position” is used herein to denote either the element's location on the surface of a tooth, its orientation or a combination of location and orientation. The term “positioning” will be used to denote the act of placing the bracket on the surface of a tooth in a desired position.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is an isometric view of a typical tray and an arch with respect to which the first embodiment of the invention may be used

FIG. 2 is an isometric view of a first embodiment of the invention.

FIG. 3a and FIG. 3b show in cross-sectional view the embodiment of FIG. 2 along A-A, when the abutment means are inactivated and activated, respectively.

FIG. 4a and FIG. 4b show in cross-sectional view variations of the embodiment of FIG. 3b, when the abutment means are activated.

FIG. 5a and FIG. 5b show in plan view variations of the balloon member of the embodiment of FIG. 2.

FIG. 6 is an isometric view of a variation of the embodiment of FIG. 2.

FIG. 7a and FIG. 7b show in cross-sectional view a variation of the embodiment of FIGS. 3a and 3b, respectively, comprising electrically actuated abutment means 2. FIG. 7c illustrates the embodiment of FIG. 7a in fragmented plan view.

FIG. 8a and FIG. 8b show in cross-sectional view a variation of the embodiment of FIGS. 3a and 3b, respectively, comprising mechanically actuated abutment means 2. FIG. 8c illustrates the embodiment of FIG. 8a in fragmented plan view. FIG. 8d illustrates a variation of the embodiment of FIG. 8c, in fragmented plan view.

FIG. 9 is an isometric view of another variation of the embodiment of FIG. 2.

FIG. 10 is an isometric view of a second embodiment of the present invention.

FIG. 11 is an isometric view of a third embodiment of the present invention.

FIG. 12 is an isometric view of a fourth embodiment of the present invention.

FIG. 13 is an isometric view of a variation of the embodiment of FIG. 12.

FIG. 14 is a fragmented front view of the tray of FIG. 1 according to the second aspect of the present invention.

FIG. 15 is a fragmented front view a variation of the embodiment of FIG. 14

### DETAILED DESCRIPTION OF THE INVENTION

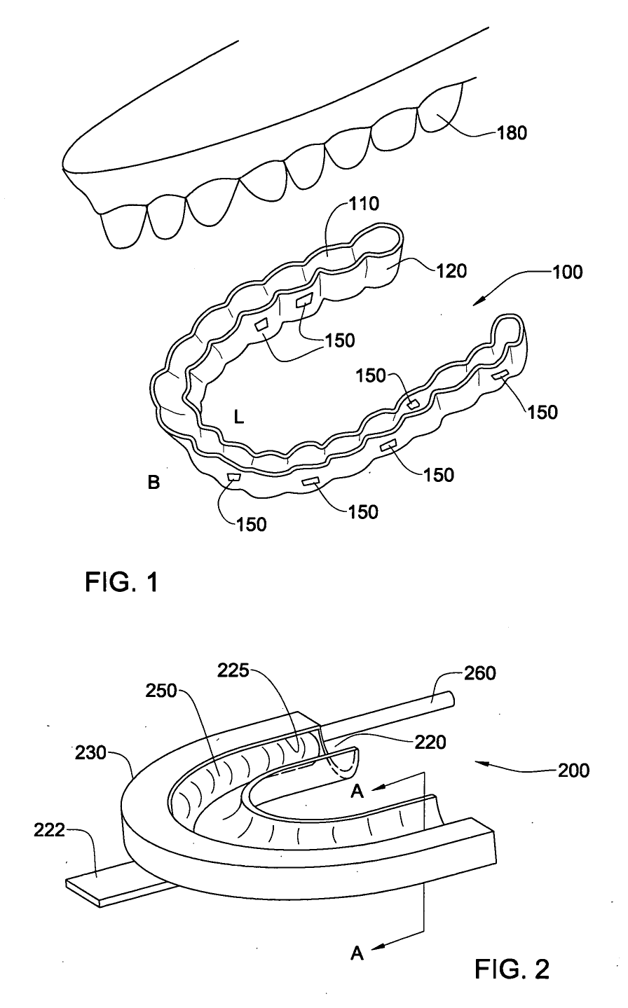

FIG. 1 illustrates a typical bracket holder, used in indirect bonding techniques, in the form of an indirect bonding transfer tray 100 that may be used in conjunction with the present invention. Such a tray comprises a flexible shell 120, typically vacuum formed and made from a thermoplastic or other suitable material. The shell 120 comprises a plurality of cavities 110 that are shaped to receive the teeth of an arch 180 regarding which it is desired to bond brackets or other orthodontic appliances to, in order to perform an orthodontic treatment. Embedded in the shell are a plurality of brackets 150, typically no more than one in each said cavity although the number of brackets per cavity may in some cases be greater. The brackets may be arranged in the buccal and/or lingual sides of the tray 100, and are positioned within the cavities at the desired relative positions vis-à-vis the teeth when the tray is seated on the arch 180.

Methods for designing and manufacturing such trays 100 are known per se in the art and will not be described further herein, except for some advantageous modifications thereof according to the second aspect of the invention, as described herein.

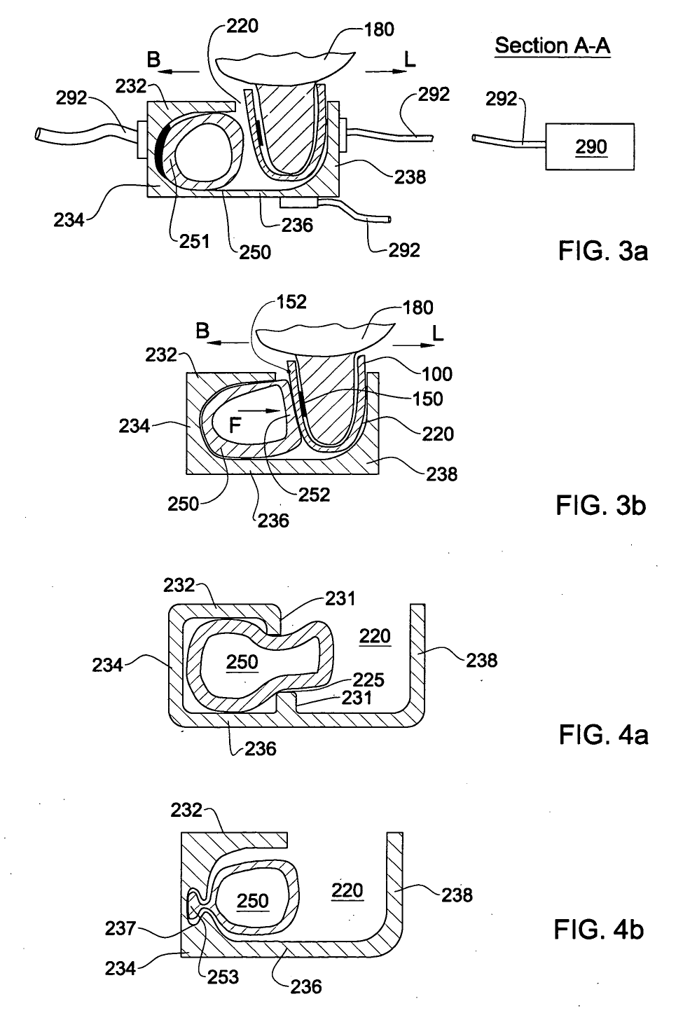

Referring to FIG. 2, a first embodiment of the present invention, according to the first aspect of the invention, is particularly adapted for facilitating the bonding of buccal/labial brackets on teeth, and comprises an urging device for urging the brackets 150 into abutting or seating contact with the buccal/labial tooth surfaces of the appropriate teeth in the arch 180 when the tray 100 is properly seated thereon. The urging device 200 according to this embodiment is in the form of a cradle having an arcuate trough 220, generally shaped to receive and hold therein an arch 180 (on which is fitted a tray 100) while the brackets are urged towards the teeth. The device 200 further comprises an arcuate housing 230 along the outer arcuate periphery of the trough 220 on the buccal/labial side B thereof. As illustrated in FIG. 3a, for example, the trough 220 comprises a relatively large cross-section relative to the cross-section of the teeth which are received therein, providing some clearance therebetween. This clearance facilitates seating of the arch onto the trough, and also enables a one-size device according to the invention to be used with patients of different ages and sex, and having teeth and arches of different sizes. The housing comprises urging means for urging each of the brackets 150, while still embedded in the tray 100, towards the appropriate tooth surface to which they are to be bonded.

In the embodiment illustrated in FIG. 2, the trough 220 and housing 230 are in mutual open communication via an opening 225 that runs along the buccal/labial side of the trough 220. The housing 220 accommodates urging means comprising an inflatable element in the form of a balloon member 250, which when in the deflated configuration is received in the housing 230 and away from the trough 220, as illustrated in FIG. 3a.

The upper wall 232, outer wall 234 and base 236 of the housing constrain the expansion of the balloon member 250, when inflated, in a direction towards the opening 225 and thenceforth towards the trough 220. Thus, as illustrated in FIG. 3b, when the balloon member 250 is in the inflated configuration, a part 252 of the balloon member 250 is forced towards the trough, and thus provides an urging force F in a lingual direction L. When an arch 180 is received in trough 220, together with a tray 100 seated on the arch 180, the urging force acts on the buccal/labial side 152 of the tray 100, and pushes this, together with any brackets that are embedded there, towards the teeth of the arch 180. The balloon member 250 is made from an elastic material and deforms to take the shape of the side 152. Thus, regardless of where each bracket may be situated on the side 152, force F acts to bring each bracket into abutting or seating contact with the tooth surface opposite thereto so that, when applied and cured, an adhesive may successfully bond the brackets to the tooth surfaces.

The balloon member 250 is in fluid communication with a suitable pressurized fluid reservoir—typically compressed air or another compressed gas, but may also comprise a liquid, such as for example a water mains—via conduit 260. Alternatively, the balloon member may be connected to a manual pump, to be actuated manually by the user when required.

Preferably, the housing 230 is adapted for keeping the balloon member 250 therein. For example, as illustrated in FIG. 3a, the buccal/labial side 251 of the balloon member may be bonded to the inner side of wall 234. Alternatively, and as illustrated in FIG. 4a, the housing 230 may comprise skirts 231 that partially close opening 225 near the upper wall 232 and base 236, so that part 252 of balloon member 250 squeezes out of opening 225 when inflated, leaving most of the balloon member 250 in the housing 230. Alternatively, and as illustrated in FIG. 4b, the balloon member 250 may comprise a plurality of integral tabs 253 at the buccal/labial side thereof that are received in and held by a suitably shaped recess 237 comprised in outer wall 234. Many other ways of adapting the housing 230 for keeping the balloon member therein are also possible within the spirit of the invention.

The housing 230 does not necessarily need to enclose the balloon member, or indeed any other form of the abutment means, but rather needs to provide a support for the abutment means with respect to the teeth. Thus, in other embodiments, the housing may be simplified and take the form of a bracket or the like onto which the balloon or other type of abutment means is mounted.

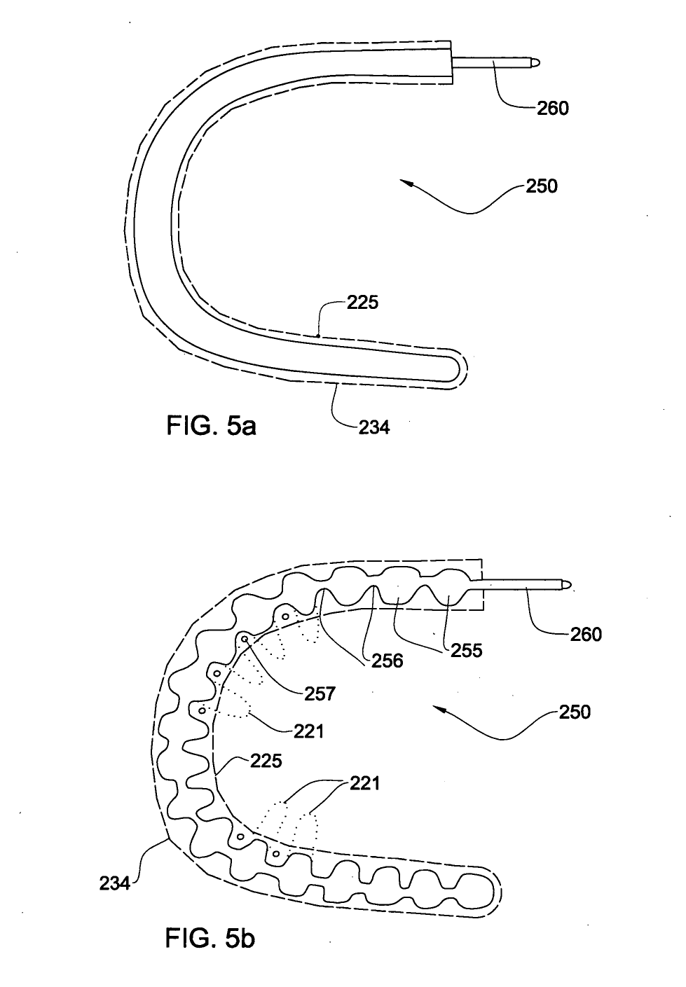

The balloon member is typically of circular transverse cross-section and follows the arcuate profile of the housing 230 and particularly of the opening 225. Alternatively, the balloon may be of any other suitable cross-section, and the cross-section may be constant along the peripheral length of the housing, as illustrated in FIG. 5a. Alternatively, the cross-section of the balloon member 250 may vary along the peripheral length of the housing. For example, and as illustrated in FIG. 5b, the balloon member 250 may comprise a plurality of globular portions 255 arranged in series, in which adjacent globular portions 255 are connected via neck sections 256. In such a case, the balloon member 250 can also be restrained in place within the housing by providing bars 257 extending from the upper wall 232 to the base 236 and situated lingually of the neck portions 256, as illustrated in FIG. 5b. The globular portions 255 are preferably designed to be in registry each one with a tooth of arch 180 when the later is received in the trough 220, so that each portion urges a different tooth when expanded, as illustrated with dotted line 221.

For use with light-curing adhesives, the device 200 optionally comprises suitable lighting means. As illustrated in FIG. 3a, the lighting means 290 may be in the form of an external source, such as for example a Xenon plasma arc unit, which is in optical communication with the lingual wall 238 of trough 220, and/or the buccal outer wall 232 and/or the occlusal base 236, and/or indeed from the gingival direction and/or the mesiodistal direction of the housing 220, for example via optic fibers 292. Optionally, the light may be provided from any other side of the tooth, and indeed from any combination thereof. Thus, light of the required frequency may be conveyed to the adhesive between the brackets and the teeth. Alternatively, suitable LED's (not shown), for example, may be provided at the lingual wall 238 of trough 220, and/or the outer wall 232 and/or the occlusal base 236 of the housing 220 to provide the required curing light when needed. The curing light may come from any one of the lingual, buccal or occlusal sides, or in any combination thereof simultaneously or in any desired sequence.

The device according to this embodiment is used as follows. A tray 100, is first designed and manufactured according to any suitable method, and comprises at least one, and typically a plurality of brackets 150 embedded therein such that the bases of the brackets, i.e., the parts of the brackets which are to abut the teeth, are exposed towards the cavity 110. Thereafter, suitable adhesive is applied to the bases of the brackets and/or to the locations on the teeth onto which the brackets are to be bonded. Alternatively, any other bonding system may be used, for example as described in U.S. Pat. No. 5,971,754, the contents of which are incorporated herein. Then, the tray 100 is seated properly onto the appropriate arch 180 such that each tooth thereof is received in the appropriate cavity 110. According to the invention, the device 200 is then inserted into the oral cavity such that the arch 180, having had a said tray 100 properly seated thereon, is received in the trough 220, and the opening 225 faces the buccal/labial faces of the teeth. Optionally, the patient may then bring together the two jaws so that the device is firmly clamped between the teeth—one arch 180 seated in the trough 220, and the opposite arch pressing against the base 236. Alternatively, the orthodontist may hold the device 200 by means of graspable projection 222. This embodiment is particularly adapted for use with trays 100 having brackets 150 embedded in the buccal/labial side thereof. The balloon member 250 is then inflated, and part 252 thereof is urged in the lingual direction, pressing against the buccal/labial side 152 of the tray 150. In turn, the brackets carried in the side 152 are each pressed against the buccal/labial tooth surface of the corresponding tooth of the arch 180. As may be readily appreciated, the balloon member 250 expands along the full periphery of the opening 225, and thus presses against the full extent of side 152 of the tray, simultaneously pressing all buccal/labial brackets 150 towards the teeth.

When a chemical adhesive is used, the balloon member 250 is held inflated for as long as required to enable the adhesive to be fully cured. When a light-cured adhesive is used, the curing light is activated after the balloon member 250 is inflated, and is held thus until the adhesive is fully cured.

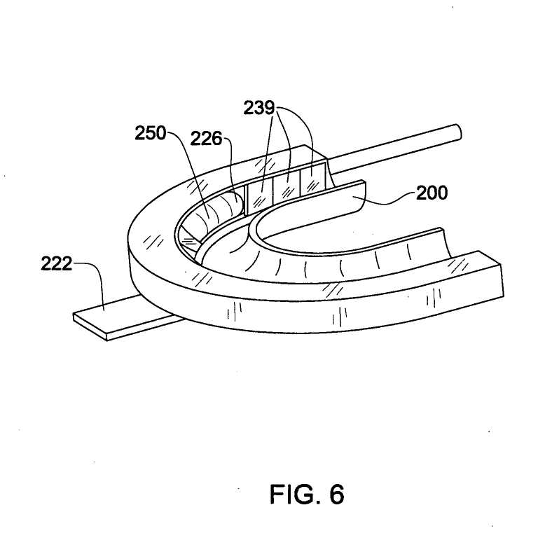

In a variation of the first embodiment illustrated in FIG. 6, parts of the opening 225 may be blocked so that the balloon member 250 is only allowed to expand at certain locations along the periphery of the opening. These locations 226 can be designed such as to concentrate the urging force F at one or more points along the periphery of side 152 of the tray 100, and thus with respect to one or more teeth of the arch 180, respectively. Such an embodiment may be useful when it is desired to urge brackets to only certain teeth while not disturbing the other teeth. Optionally, opening 225 may be selectively blocked using removable plates 239 that may be reversibly mounted to the opening where required. This builds in versatility into the device, and allows any desired one or combination of teeth to be acted on by the balloon means as desired.

As described above, the first embodiment comprises a balloon member as the urging means for urging the brackets into abutting contact with the corresponding tooth surfaces. Alternatively, the abutting means could take any other suitable form, and be based on any suitable actuator configuration including any manual or powered actuator arrangement. For example, a manual arrangement may be actuated by the orthodontist or an assistant, and may comprise, for example, spring-actioned pistons which are loaded manually and then released manually when the device is properly seated on the teeth. Powered actuators may be in any other hydraulic or pneumatic form, or indeed may be based on electrical actuation, mechanical actuation, and so on. Optionally, the actuation means may be any suitable combination of manual and powered means, and may include any combination of different forms of manual actuators and/or powered actuators.

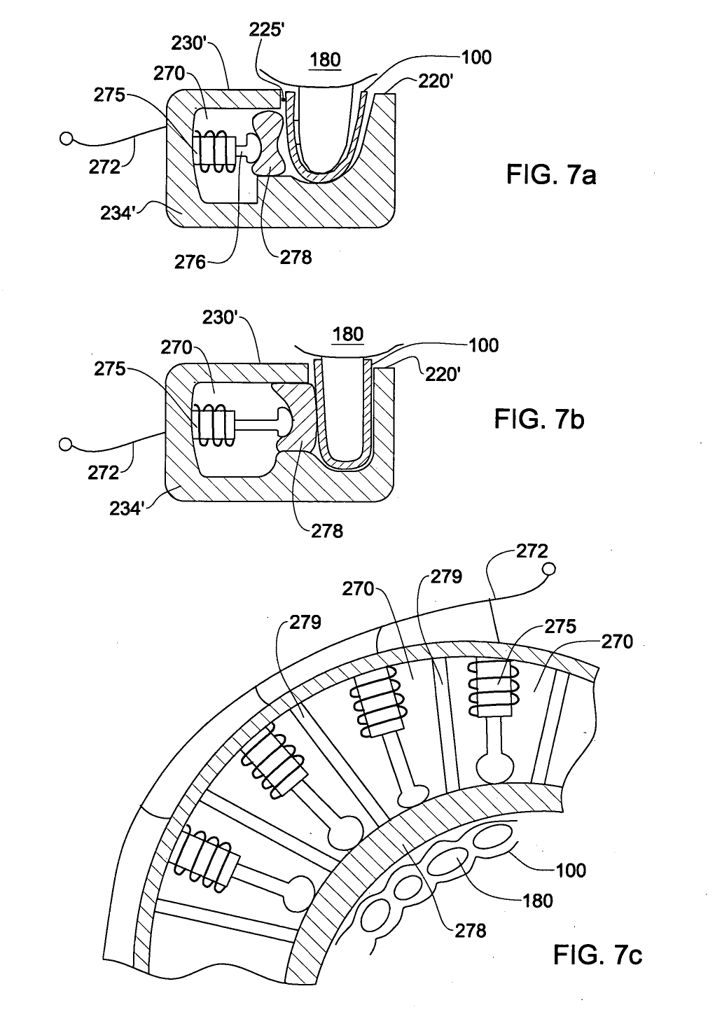

For example, and referring to FIGS. 7a, 7b and 7c, exemplary urging means based on electrical actuation are illustrated. In this variation of the first embodiment, the housing 230′ is radially divided into a series of adjacent cells 270, each cell 270 comprising an electrical actuator 275. The electrical actuators are anchored on the inner part of outer wall 234′, and in the example illustrated in FIGS. 7a, 7b and 7c they each comprises a piston arrangement 276 which reciprocates between a retracted position and an extended position illustrated in FIGS. 7a and 7b, respectively. The piston arrangement 276 may operate in any number of ways, and may include, for example, a solenoid arrangement, or a mini motor coupled with a jack to effect the required movement when actuated electrically. A pressure pad 278, preferably made from a resiliently deformable material, is provided at the opening 225′ of the housing 230′, and this deforms outwardly when pressed by the piston arrangement. Advantageously, a piston arrangement 275 is provided opposite every expected location of a tooth of an arch 180 that is received in trough 220′. Accordingly, on actuation of each, piston arrangement 275, the part of the tray opposite the same is urged against the corresponding tooth, thereby enabling a bracket comprised in this part of the tray to be bonded to the tooth. Preferably, all the pistons 275 are actuated simultaneously, thereby pressing the full buccal/labial side of the tray towards the arch 180. Optionally, individual pressure pads 278 may be provided for each cell 270, or alternatively a single continuous pressure pad may be used extending along the curved length of opening 225′. Optionally, the piston arrangements 275 are provided within the housing in communication with each other, without the dividing cell walls 279. The piston arrangements 275 are operatively connected to a suitable control unit (not shown) via wiring 272.

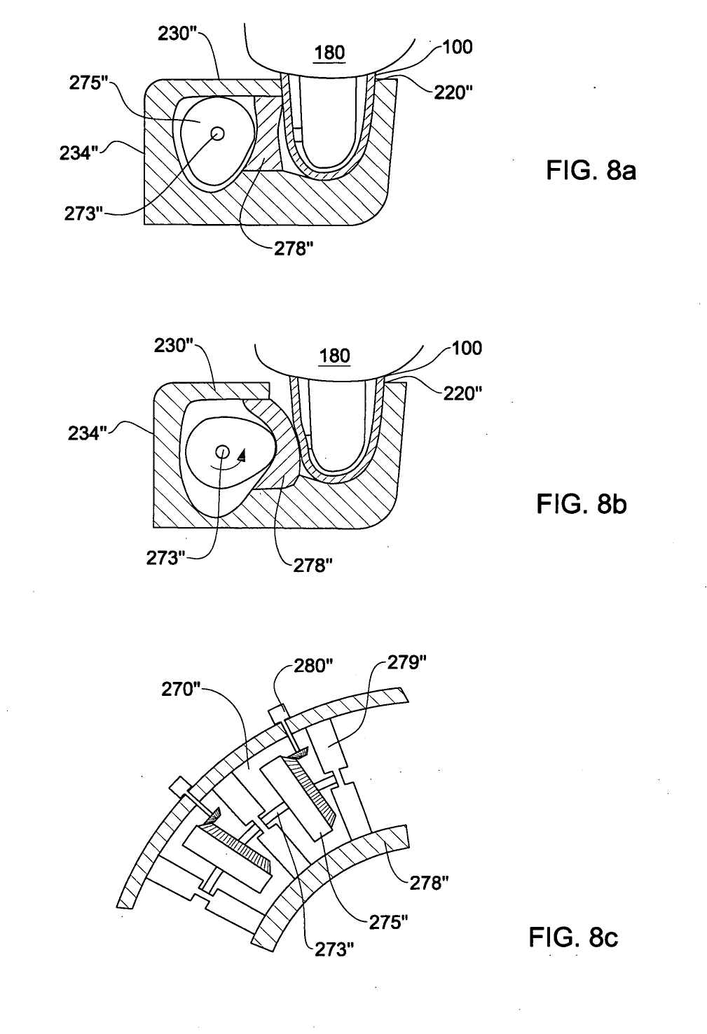

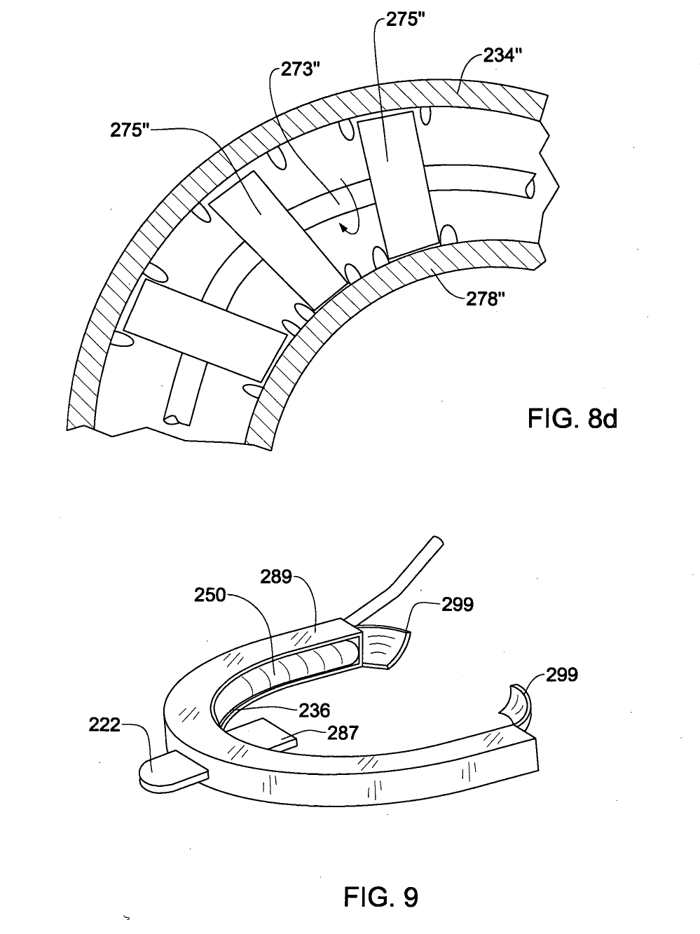

In another example, and referring to FIGS. 8a, 8b, and 8c, exemplary urging means based on mechanical actuation are illustrated. In this variation of the first embodiment, the housing 230″ is radially divided into a series of adjacent cells 270″, each cell 270″ comprising a mechanical actuator 275″. The mechanical actuators are each in the form of an eccentric wheel or preferably a cam arrangement 276″, and allowed to rotate within the cell about shaft 273″ between a raised position and a return position illustrated in FIGS. 8b and 8a, respectively. The cam arrangement 276″ may be turned in any number of ways, and may include, for example, a solenoid arrangement, a manual mechanism or a mini motor (not shown) coupled with shaft 273″ to effect the required movement when actuated electrically, as best illustrated in FIG. 8c. A pressure pad 278″ is provided at the opening 225″ of the housing 230″, and this deforms outwardly when pressed by the cam arrangement. Advantageously, a cam arrangement 275″ is provided opposite every expected location of a tooth of an arch 180 that is received in trough 220″. Accordingly, on actuation of each cam arrangement 275″ to the raised position, the part of the tray opposite the same is urged against the corresponding tooth, thereby enabling a bracket comprised in this part to be bonded to the tooth. Preferably, all the cams 275″ are actuated simultaneously, thereby pressing the full buccal/labial side of the tray towards the arch 180. Optionally, individual pressure pads 278″ may be provided for each cell 270″, or alternatively a single continuous pressure pad may be used extending along the curved length of opening 225″. Optionally, and as illustrated in FIG. 8d, the cam arrangements 275″ are provided within the housing in communication with each other, without the dividing cell walls 279″, and thus comprises a shaft 273″ which is either flexible or comprises universal joints or the like between adjacent cams to account for the curvature of housing 230″. In such an arrangement it is possible to have a phase difference between adjacent cams 275″, and the sequence in which the cams 275″ are actuated may be user defined. The cam arrangements 275″ are operatively connected to a suitable control unit (not shown). Optionally, the mechanical arrangement of FIGS. 8a, 8b, 8c and 8d may also be adapted for manual actuation, rather than powered actuation.

In the first embodiment, the lingual wall 238 provides a reaction to the abutment force F, and the base part 239 of the trough 230 limits the depth of penetration of the arch 180 into the trough 230, assisting in aligning the abutment means with main portion of the teeth surfaces onto which the brackets are to be bonded. However, it is sufficient only to immobilize the device 200 as a whole with respect to the tray 100 and arch 180 while the urging means are in operation. Thus the trough base part 239 and the lingual wall 238 may be replaced with a suitable clamping, locking, or any other immobilizing arrangement for clamping, locking or otherwise immobilizing the device 200 with respect to the arch. Such an immobilizing arrangement may comprise, for example, hooks or end cups 299 arranged at the free ends of the arms 289 of the housing, as illustrated in FIG. 9, wherein the cups 299 are designed to engage the distal ends of the last teeth, typically molars, of the arch 180. Optionally, a tab 287 may be provided projecting inwardly from the base 236, and the tab may be clamped between the upper and lower arches of a patient, to further stabilize the device with respect to the teeth.

In this embodiment, the brackets 150 are urged into abutting contact with the teeth indirectly, as the abutment means act on the tray itself. In embodiments of the tray, where parts of the brackets 150 may protrude to the outside of the tray 100, the brackets 150 may be urged directly by the abutment means.

The housing 230 and trough 220 are preferably made from rigid or semi rigid materials, preferably medically compatible materials, and further from materials that are readily sterilisable, particularly via autoclave or the like. Preferably, the housing 230 and trough 220 are integrally formed. In particular, such materials generally conform to regulations and standards for dental devices of the appropriate Authority under whose jurisdiction the device 200 is manufactured or used.

The device according to the first embodiment may be used for either the upper arch or the lower arch of a patient's dentition, merely be inverting the device to enable proper alignment of the trough 220 with the appropriate arch 180.

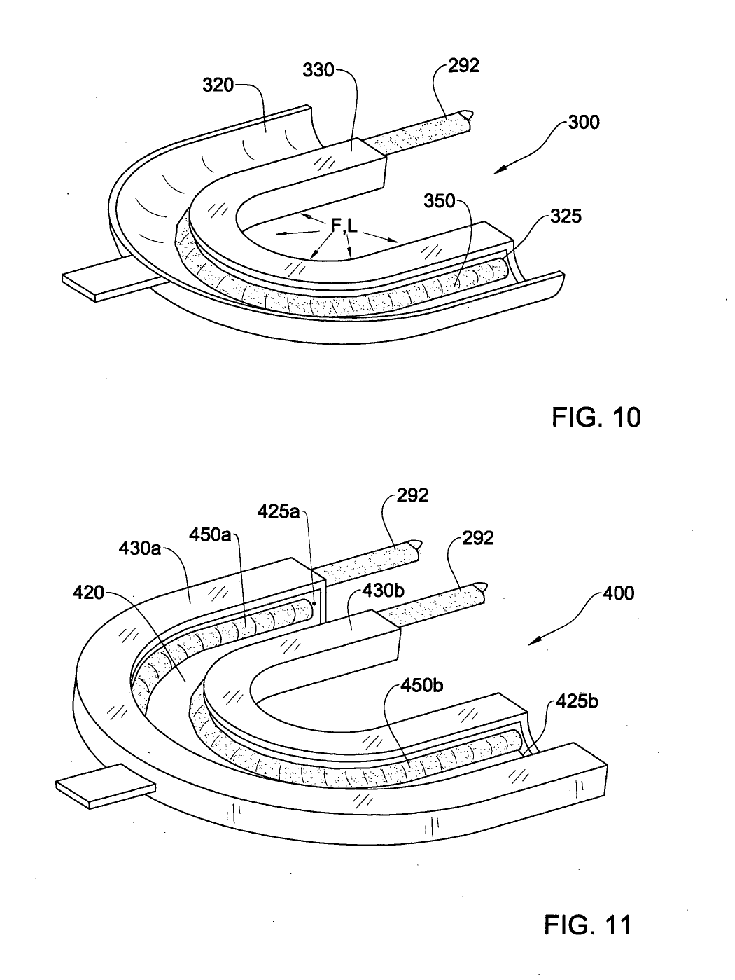

A second embodiment of the present invention, illustrated in FIG. 10, is particularly adapted for facilitating the bonding of lingual brackets on teeth, and comprises an urging device for urging the brackets 150 into abutting or seating contact with the lingual tooth surfaces of the appropriate teeth in the arch 180 when the tray 100 is properly seated thereon. The device according to the second embodiment thus comprises a device 300 comprising all the features and elements as described for the first embodiment including all variations of the urging means, mutatis mutandis, with the main difference being that urging force F is provided in the buccal/labial direction B, i.e. towards the lingual side of the tray 100. Accordingly, for example, housing 330 comprising balloon member 350 and opening 325—or indeed any other suitable urging means—are provided along the lingual periphery of the trough 320, rather than of the buccal/labial periphery described for the first embodiment.

A third embodiment of the present invention, illustrated in FIG. 11, is particularly adapted for facilitating the bonding of lingual brackets as well as buccal/labial brackets on teeth, and comprises an urging device for urging the brackets 150 into abutting or seating contact with the lingual and/or buccal/labial tooth surfaces of the appropriate teeth in the arch 180 when the tray 100 is properly seated thereon. The device according to the third embodiment thus comprises a device 400 comprising all the features and elements as described for the first and second embodiments including all variations of the urging means, mutatis mutandis, with the main difference that urging force F may be provided in both the lingual direction L and the buccal/labial direction B. Accordingly, for example, two housings 430a and 430b, comprising balloon members 450a and 450b, and respective openings 425a and 425b are provided along the lingual and buccal/labial peripheries, respectively, of the trough 420, rather than only of the buccal/labial periphery as in the first embodiment, or only of the lingual periphery described for the second embodiment. Of course, any other suitable urging means may be included for providing one or both of the lingual and/or buccal urging force(s).

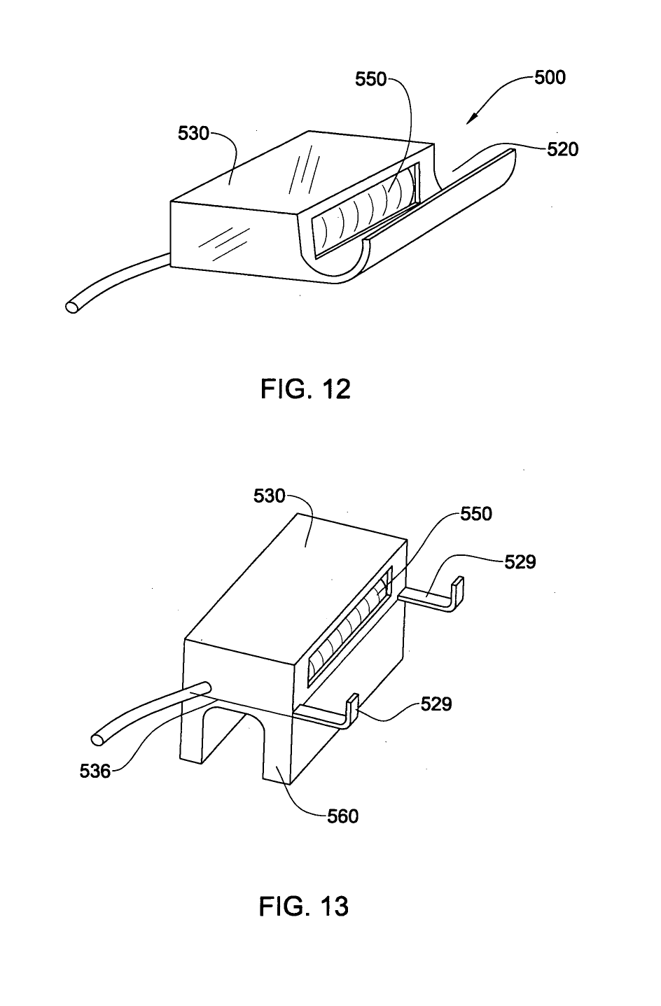

A fourth embodiment of the present invention is illustrated in FIG. 12 and is similar to the first embodiment, mutatis mutandis, with the difference that this embodiment is particularly adapted for providing an abutting force to a full tray 100 covering a complete arch 180, or to a partial tray covering only one or a group of teeth, less than the full arch, wherein the abutting force is directed at only a single tooth or at a group of adjacent teeth. The device 500 comprises a trough 520 which is of a length correlated to the width of the tooth or to the width of the arch segment comprising the required group of teeth. As with the first embodiment, a balloon member 550 is provided for applying the abutment force, but any other abutment means can be used, for example as described for the first embodiment, mutatis mutandis. Particularly where the device 500 is adapted for applying an abutment force to a small number of teeth, the trough 520 may be substantially rectilinear, and thus may be used for any suitable group of teeth in arch 180, for either one of the upper or lower arches, and for providing either a lingual or a buccal/labial abutment force.

In another variation of the fourth embodiment, illustrated in FIG. 13, the trough arrangement 520 may be replaced with one or a plurality of hooks 529 which are designed to align and immobilize the device 500 with respect to the teeth, and thus provide the appropriate reaction to the abutment force provided by the abutment means. Alternatively or additionally, an inverted trough 560 may be provided, for example on the base 536 of housing 530 which engages with the teeth of the opposite arch when the jaws of the patient are closed.

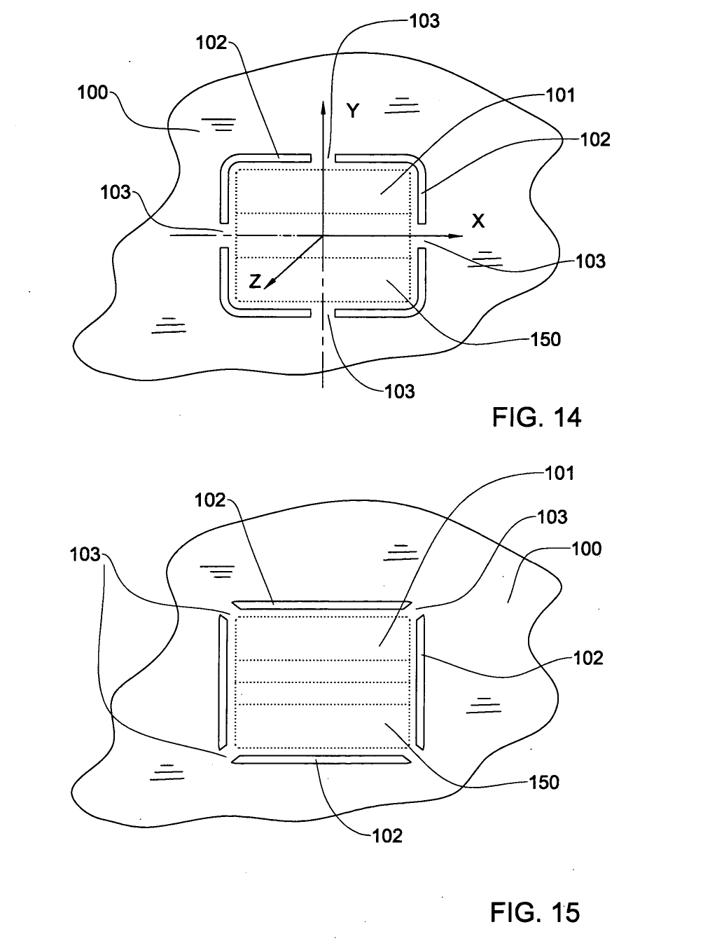

In another aspect of the present invention, the tray 100 may be modified to better allow the brackets 150 embedded therein to be abutted or seated against the corresponding teeth. Referring to FIG. 14, a portion of a tray 100 is illustrated comprising a bracket 150, which may be a lingual or buccal/labial bracket. According to this aspect of the invention, the tray 100 is provided with weakened portions around the periphery of at least some of, and preferably all of, the areas 101 on which the brackets 150 are embedded. Such areas are typically of the same shape though slightly larger than the plan form of the corresponding bracket 150. In the embodiment illustrated in FIG. 14, slits 102 are provided along the periphery of the areas 100 such as to leave four connection bridges 103 between each area 101 and the surrounding body of the tray 100. Alternatively, of course, more than 4 or less than 4 bridges 103 may be provided. In this embodiment, the bridges are arranged along the orthogonal axes X, Y, of the base of the bracket, and thus permit the area 101 together with the bracket to partially rotate about these two axes. Due to the flexibility of the material from which the tray 100 is made from, limited rotation about the third axis, Z (out of the paper in FIG. 14), and limited translations in all three directions is also possible. This mobility of the bracket 150 with respect to the tray 100 greatly facilitates the procedure of bonding the brackets to the teeth, specially when a device according to the first aspect of the present invention is used. Ideally, the bridges are as narrow as possible to maximize the mobility of the area 101, but at the same time comprises sufficient material such that the part 101 is not ripped off when the tray is originally formed and removed from the plaster model with the brackets. Alternatively, the slits 102 may be replaced with an arrangement of perforations. Alternatively, instead of slits 102, the said weakened portions may comprise a material thickness that is thinner or smaller than that of the rest of the tray 100.

In FIG. 15, a variation of the embodiment of FIG. 14 is illustrated, mutatis mutandis, wherein an alternative arrangement for slits 102 is provided, the bridges 103 being now formed at the corners of the area 101.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed exemplary embodiments in accordance with the invention, it will be appreciated that many changes may be made therein without departing from the spirit of the invention.

1. A device for applying an abutment force between a dental appliance carried on a holder and at least one tooth, said holder being adapted for seating on said one or more teeth such that said appliance is in registry with said at least one tooth, the device comprising:—
abutment means; and
mounting means for mounting the device with respect to said at least one tooth and said holder,
wherein said abutment means are adapted for generating a suitable force for urging the appliance into abutting contact with said at least one tooth.

2. A device according to claim 1, wherein said mounting means comprises at least one of:—
a trough generally shaped to receive said one or more teeth having seated thereon said holder;
hook elements for hooking the device with respect to at least one said tooth;
cups that engage with the end teeth of an arch comprising said at least one tooth;
an inverted trough adapted for receiving and engaging at least a part of an arch in an intraoral cavity in occlusal arrangement with respect to an arch that comprises said at least one tooth.

3. A device according to claim 2, wherein said mounting means comprises said trough, and said device comprises a housing accommodating said abutment means, said housing comprising an opening in communication with said trough.

4. A device according to claim 3, wherein said abutment means is based on any one of suitable manual or powered actuation including any one or combination of pneumatic, hydraulic, electrical or mechanical actuation.

5. A device according to claim 4, wherein said abutment means comprise an inflatable element, said inflatable element being reversibly inflatable from a deflated configuration to an inflated configuration, wherein in said inflated configuration at least a part of said inflatable element is pressed against the said holder at least in a vicinity of said appliance such that said appliance is abutted against said at least one tooth.

6. A device according to claim 5, wherein said inflatable element is in the form of a balloon member accommodated in said housing, and wherein said inflatable element is operatively connectable to a suitable pressurized fluid supply.

7. A device according to claim 5, wherein said device is adapted for applying an abutment force between an dental appliance carried on a holder and at least one tooth of an arch, wherein said holder is adapted for being seated over the full said arch, said trough having a plan profile substantially similar to that of said arch for receiving and holding therein said arch with said holder seated thereon.

8. A device according to claim 5, wherein said housing comprises a plan profile substantially similar to that of said arch.

9. A device according to claim 5, wherein said housing is arranged one of buccally or lingually with respect to said trough.

10. A device according to claim 9, further comprising a second said housing having suitable second abutment means, wherein said second housing is arranged the other one of lingually or buccally with respect to said trough.

11. A device according to claim 1, wherein said device is adapted for applying said force to a plurality of orthodontic elements comprised in said appliance substantially simultaneously.

12. A device according to claim 1, further comprising light transmission means for transmitting light to an abutment area between said appliance and said at least one tooth during operation of said device.

13. A device according to claim 12, wherein said light is of a wavelength suitable for curing light-curable adhesive that may be used for bonding said one or more appliance to said one or more teeth, and wherein said light is provided in any one of a buccal, lingual, mesiodistal, occlusal or gingival direction or combination of at least two thereof.

14. A device according to claim 1, wherein said appliance comprises at least one orthodontic element including at least one orthodontic bracket.

15. A method for abutting a dental appliance to at least one tooth, said appliance being carried on a holder, comprising the steps of:
seating said holder on said at least one tooth such that said appliance is in registry with said at least one tooth;
mounting an abutment device with respect to said holder and said at least one tooth, said device comprising:—abutment means; and mounting means for mounting the device with respect to said at least one tooth and said holder,
generating a suitable abutment force via said abutment means for urging said appliance into abutting contact with said at least one tooth.

16. A method according to claim 15, further comprising the step of bonding said appliance to said at least one tooth.

17. A method for bonding a dental appliance to at least one tooth, said appliance being carried on a holder, comprising the steps of:
seating said holder on said at least one tooth such that said appliance is in registry with said at least one tooth;
mounting an abutment device with respect to said holder and said at least one tooth, said device comprising:—abutment means; and mounting means for mounting the device with respect to said at least one tooth and said holder,
generating a suitable abutment force via said abutment means for urging said appliance into abutting contact with said at least one tooth;
bonding said appliance to said at least one tooth.

18. A method according to claim 17, wherein said holder is in the form of a tray and adapted for being seated over the full said arch, and wherein said mounting means is in the form of a trough having a plan profile substantially similar to that of said arch for receiving and holding therein said arch with said holder seated thereon.

19. A method according to claim 18, wherein said appliance is to be bonded one of lingually or buccally to a said at least one tooth, and said abutment force is applied buccally or lingually, respectively, with respect to said tooth.

20. A method according to claim 19, wherein said appliance is to be bonded lingually or buccally to at least one said tooth, and further comprising the step of applying a second abutment force, wherein said second abutment force is applied buccally or lingually, respectively, with respect to said tooth.

21. A method according to claim 18, wherein appliance comprises a plurality of brackets and said abutment force is applied to said plurality of brackets substantially simultaneously.

22. A method according to claim 18, wherein at least one of:
a light-curing adhesive is applied to said appliance prior to seating said holder on said at least one tooth, and further comprises the step of applying a light transmission to an abutment area between said appliance and said at least one tooth during operation of said device; and
a chemically-curing adhesive is applied to said appliance prior to seating said holder on said at least one tooth.

23. A method according to claim 18, wherein said appliance comprises at least one orthodontic element including at least one orthodontic bracket.
